(19) United States
(12) Patent Application Publication
(10) Pub. No.: US 2026/0050232 A1
(43) Pub. Date: Feb. 19, 2026

(54) DEVELOPING DEVICE

(71) Applicant: FUJIFILM Business Innovation Corp., Tokyo (JP)

(72) Inventors: Yasuhisa GONDA, Kanagawa (JP); Shunsuke YAMASAKI, Kanagawa (JP); Kazunari ISHII, Kanagawa (JP); Yuta SHIMATATE, Kanagawa (JP); Chihiro TONE, Kanagawa (JP)

(73) Assignee: FUJIFILM Business Innovation Corp., Tokyo (JP)

(21) Appl. No.: 19/048,996

(22) Filed: Feb. 10, 2025

(30) Foreign Application Priority Data
Aug. 14, 2024 (JP) 2024-135312

(51) Int. Cl. G03G 15/08

(52) U.S. Cl. CPC G03G 15/0898; G03G 2215/0634

(57) ABSTRACT

A developing device includes a development roll that rotates while holding a developer, an image holding body that is disposed to face the development roll and that rotates, and a developer discharging duct through which the developer is sucked from an image holding body side and the developer is discharged to another place, in which the developer discharging duct includes a duct front wall that is disposed on the image holding body side and that has suction ports for sucking the developer, which are formed in end portions of the duct front wall on both sides in an intersection direction intersecting a rotation movement direction of the development roll, a duct rear wall that is positioned on a side opposite to the image holding body with respect to the duct front wall, and two duct side walls that are positioned at the end portions on both sides in the intersection direction, a discharge port for discharging the developer is formed in one duct side wall of the two duct side walls, at a position adjacent to the duct rear wall, and a side intake port for sucking air is formed in one duct side wall of the two duct side walls.

### CROSS-REFERENCE TO RELATED APPLICATIONS

This application is based on and claims priority under 35 USC 119 from Japanese Patent Application No. 2024-135312 filed Aug. 14, 2024.

### BACKGROUND

### (i) Technical Field

The present invention relates to a developing device.

### (ii) Related Art

An electrophotographic image forming apparatus has a developing device including an image holding body and a developer supply device that supplies a developer to the image holding body. The developing device includes a development roll that holds the developer on a surface thereof. The developer held by the development roll is migrated to the image holding body, and an electrostatic latent image on the image holding body is developed. Some of the developer that is not used in development floats in the vicinity of the development roll and the image holding body. A technique of collecting the floating developer is described in JP2003-177604A and JP2013-125148A.

JP2013-125148A describes a technique of discharging a developer deposited in a flow passage for collecting a floating developer. In this document, in a case of non-image formation, air is introduced into the flow passage from an intake port different from an intake port in a case of image formation to generate a strong air flow. Then, the developer deposited by the air flow is discharged from the flow passage.

### SUMMARY

In a case where the developer is deposited in the flow passage for collecting the developer together with the air flow, the flow passage is narrowed and is blocked in some cases. In recent years, there is a demand for an increase in speed of an image forming apparatus, and with the increase in speed, the amount of a collected developer increases, and a probability of blockage of the flow passage increases.

Aspects of non-limiting embodiments of the present disclosure relate to a developing device that suppresses deposition of a developer in a flow passage for collecting the developer.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to a first aspect of the present invention, there is provided a developing device including a development roll that rotates while holding a developer, an image holding body that is disposed to face the development roll and that rotates, and a developer discharging duct through which the developer is sucked from an image holding body side and the developer is discharged to another place, in which the developer discharging duct includes a duct front wall that is disposed on the image holding body side and that has suction ports for sucking the developer, which are formed in end portions of the duct front wall on both sides in an intersection direction intersecting a rotation movement direction of the development roll, a duct rear wall that is positioned on a side opposite to the image holding body with respect to the duct front wall, and two duct side walls that are positioned at the end portions on both sides in the intersection direction, a discharge port for discharging the developer is formed in one duct side wall of the two duct side walls, at a position adjacent to the duct rear wall, and a side intake port for sucking air is formed in one duct side wall of the two duct side walls.

### BRIEF DESCRIPTION OF THE DRAWINGS

Exemplary embodiment(s) of the present invention will be described in detail based on the following figures, wherein:

FIG. 1 is a perspective view showing an appearance of a developer supply device of a developing device of the present exemplary embodiment;

FIG. 2 is a cross-sectional view taken along line A-A shown in FIG. 1 of the developing device of the present exemplary embodiment;

FIG. 3 is a view schematically showing a structure of a developer discharging duct;

FIG. 4 is an external view showing a side intake port of the developer supply device and a periphery thereof; and

FIG. 5 is a view showing a schematic configuration of an image forming apparatus.

### DETAILED DESCRIPTION

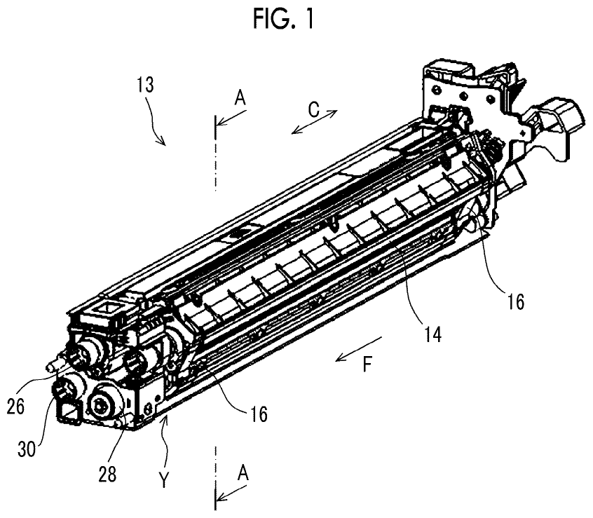

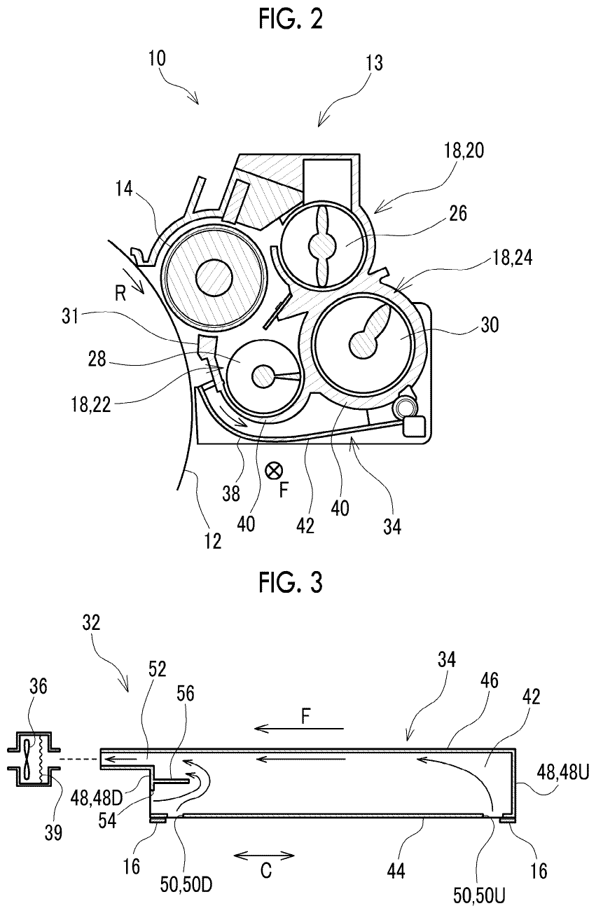

Hereinafter, an exemplary embodiment of the present invention will be described with reference to the drawings. FIGS. 1 and 2 are views showing schematic configurations of a developing device 10 provided in an electrophotographic image forming apparatus. The developing device 10 includes an image holding body 12 and a developer supply device 13 that supplies a developer to the image holding body 12. FIG. 1 is a view showing an appearance of the developer supply device 13. FIG. 2 is a cross-sectional view taken along line A-A shown in FIG. 1, and a part of the image holding body 12 is shown in addition to the developer supply device 13. An up-down direction of FIGS. 1 and 2 corresponds to a direction of gravity in a case where the developing device 10 is installed in the image forming apparatus.

The developing device 10 is disposed in the image forming apparatus in a state where the image holding body 12 and the developer supply device 13 face each other. In the image holding body 12, an electrostatic latent image is formed on a surface thereof, and the electrostatic latent image is developed with a developer supplied from the developer supply device 13. A developer image formed on the surface of the image holding body 12 through the development is transferred onto a recording medium, such as paper, or an intermediate transfer body. The developer image transferred to the intermediate transfer body is transferred to the recording medium later. The developer may be a toner. The image holding body 12 is, for example, a cylindrical photosensitive roll and rotates about a center line of the cylinder. A rotation direction of the image holding body 12 is indicated by an arrow R in FIG. 2. By this rotation, the developer image is sequentially formed on the image holding body 12 at a position facing the developer supply device 13, and the developer image is further sent to a position where the developer image is transferred to the recording medium.

The developer supply device 13 includes a development roll 14 that holds a developer to be supplied to the image holding body 12. The development roll 14 is disposed to face the image holding body 12. The development roll 14 has a cylindrical shape, and a center line thereof is disposed along a direction in which the center line of the cylindrical image holding body 12 extends. In addition, the development roll 14 is disposed close to the image holding body 12 with a gap formed therebetween. A region sandwiched between the development roll 14 and the image holding body 12 will be hereinafter referred to as a “nip”. The development roll 14 rotates about the center line. A direction of the rotation is a direction in which directions of movement of surfaces of the development roll 14 and the image holding body 12, respectively, are aligned at a portion facing the image holding body 12. Directions of rotation of the image holding body 12 and the development roll 14 may be opposite to each other. In a portion where the development roll 14 and the image holding body 12 face each other, a direction in which the surface moves with the rotation will be hereinafter referred to as a “rotation movement direction”, and a direction intersecting the rotation movement direction will be hereinafter referred to as an “intersection direction”. The intersection direction is also a direction in which the center line of the development roll 14 extends.

A developer on the surface of the development roll 14 is stuck to and held by the development roll 14 with a magnetic force. The developer is supplied to the nip as the development roll 14 rotates, and an electrostatic latent image on the image holding body 12 is developed. In the intersection direction, seal pieces 16 are disposed at both end portions of the nip (see FIG. 1). The seal pieces 16 suppress outflow of the developer floating in the nip and a peripheral region thereof from the region along the intersection direction.

The developer supply device 13 has a developer transport passage 18 through which a developer is supplied to the development roll 14 and the developer is collected from the development roll 14. The developer transport passage 18 includes three linear developer transport passages 20, 22, and 24. The number of developer transport passages 18 is not limited to three. Each of the three linear developer transport passages 20, 22, and 24 extends along the intersection direction and sends the developer along the intersection direction while agitating the developer. The developer is charged by agitating. The developer transport passage 18 further includes a conveyance transport passage (not shown) for conveying the developer between the linear developer transport passages 20, 22, and 24. The developer transport passage 20 is a transport passage for supplying the developer to the development roll 14 and hereinafter, will be referred to as a supply developer transport passage 20. In the supply developer transport passage 20, the developer is transported along the intersection direction and is supplied to the development roll 14. The developer transport passage 22 is a transport passage for transporting the developer collected from the development roll 14 and hereinafter, will be referred to as a collected developer transport passage 22. The developer transport passage 24 is a transport passage for sending the developer conveyed from the collected developer transport passage 22 toward the supply developer transport passage 20 and hereinafter, will be referred to as an intermediate developer transport passage 24.

A first transport screw 26 having a spiral blade is disposed in the supply developer transport passage 20. The first transport screw 26 is disposed such that a rotation axis line thereof extends along a direction in which the supply developer transport passage 20 extends. In a case where the first transport screw 26 rotates, the spiral blade thereof sends the developer along the direction in which the transport passage extends, and in the process, the developer is sent out toward the development roll 14 over the entire length of the development roll 14. A second transport screw 28 having a spiral blade is disposed in the collected developer transport passage 22. The second transport screw 28 is disposed such that a rotation axis line thereof extends along a direction in which the collected developer transport passage 22 extends. In a case where the second transport screw 28 rotates, the spiral blade sends the collected developer along the direction in which the transport passage extends. The developer is conveyed to the intermediate developer transport passage 24 at an end portion of the collected developer transport passage 22 to which the developer is sent. A third transport screw 30 having a spiral blade is disposed in the intermediate developer transport passage 24. The third transport screw 30 is disposed such that a rotation axis line thereof extends along a direction in which the intermediate developer transport passage 24 extends. In a case where the third transport screw 30 rotates, the developer is transported from an end portion of the intermediate developer transport passage 24, on a side to which the developer is sent from the collected developer transport passage 22, toward the other end portion. The developer sent to the other end portion is sent to an end portion of the supply developer transport passage 20. A permanent magnet that rotates together with the first transport screw 26 may be used in conveying the developer to the supply developer transport passage 20. The permanent magnet is provided as a part of a cylindrical body that is integrally provided with the first transport screw 26 coaxially. The developer in the intermediate developer transport passage 24 is stuck to the permanent magnet and is transported to the supply developer transport passage 20 through the rotation of the cylindrical body. In the intermediate developer transport passage 24, the stuck developer is scraped off and sent out to the supply developer transport passage 20.

A developer transported in the developer transport passage 18 is transported in a meandering manner. In the collected developer transport passage 22, the developer is transported from the front to the back of the paper surface in FIG. 2, is transported from the back to the front of the paper surface in the intermediate developer transport passage 24, and is transported from the front to the back of the paper surface again in the supply developer transport passage 20. A direction in which the developer is transported in the collected developer transport passage 22 will be hereinafter referred to as a “collected developer transport direction”. The collected developer transport direction is indicated by an arrow F in FIGS. 1 and 2.

A surplus portion of a developer held on the development roll 14 is scraped off such that a thickness thereof is a predetermined value. A raised developer that remains on the surface of the development roll 14 after passing through the nip moves together with the rotation of the development roll 14 and some of the raised developer collides with a structure (for example, a portion indicated by reference symbol 31 in FIG. 2) around the development roll 14. The developer is scattered by impact in this case. In addition, even in a case where the developer falls into the collected developer transport passage 22, the developer scatters due to the impact of the fall. The scattered developer floats in a region around the nip. A developer discharging device 32 is provided in order to collect the floating developer (see FIG. 3).

FIG. 3 is a view schematically showing a configuration of the developer discharging device 32. The developer discharging device 32 includes a developer discharging duct 34 provided integrally with the developer supply device 13 and a suction fan 36 connected to the developer discharging duct 34 via a pipe. The developer discharging duct 34 is disposed on a downstream side of the nip in the rotation movement direction of the image holding body 12 and the development roll 14. Air in the region around the nip is sucked by the suction fan 36 via the developer discharging duct 34. A developer contained in the sucked air flow is captured by a filter 39 disposed upstream of the suction fan 36.

As shown in FIG. 2, the developer discharging duct 34 may be formed of a part of a component that defines the developer transport passage 18 and a lower cover 38 that faces the part of the component. In the developer transport passage 18, particularly the developer supply device 13, sucked air flows in a region sandwiched between a lower portion (a portion indicated by reference symbol 40 in FIG. 2) of a component, which defines the collected developer transport passage 22 and the intermediate developer transport passage 24, and the lower cover 38.

In FIG. 3, a lower side is a side facing the image holding body 12. The developer discharging duct 34 has a duct bottom plate 42, a duct front wall 44 that is erected on an edge of the duct bottom plate 42 on an image holding body side, a duct rear wall 46 that is erected on an edge of the duct bottom plate 42 on a side opposite to the image holding body 12, and a duct side wall 48 that is erected on each of edges on both sides of the duct bottom plate 42 in an intersection direction (C). As shown in FIG. 2, the duct bottom plate 42 is curved, but in FIG. 3, the duct bottom plate 42 is shown in a state of being unfolded and flattened. The duct bottom plate 42 may be a part of the lower cover 38. The duct front wall 44, the duct rear wall 46, and the duct side walls 48 each may be a part of the lower cover 38, and some or all of these may be provided as a part of another component of the developer supply device 13.

In a case where the two duct side walls 48 need to be distinguished, the duct side wall 48 on an upstream side in a collected developer transport direction (F) will be referred to as an upstream duct side wall 48U, and the duct side wall 48 on a downstream side will be referred to as a downstream duct side wall 48D.

A suction port 50 that sucks a developer together with air around both end portions of the duct front wall 44 in the intersection direction (C) is formed. In a case where the two suction ports 50 need to be distinguished, the suction port 50 on the upstream side in the collected developer transport direction (F) will be referred to as an upstream suction port 50U, and the suction port 50 on the downstream side will be referred to as a downstream suction port 50D. The suction port 50 may be formed at a position separated away from the duct side wall 48 such that the suction port 50 does not overlap the seal piece 16 disposed at the end portion. An air flow generated with the rotation of the image holding body 12 and the development roll 14 is directed toward the nip and is further directed toward both ends of the nip along the intersection direction (C) by being blocked by the narrow nip. A developer floating in the air flow has a high density at an end portion of the image holding body 12. The suction ports 50 are formed at both end portions of the duct front wall 44 corresponding to regions where the density of the floating developer is high. A suction port may be provided additionally between both end portions.

A discharge port 52 for discharging a developer together with an air flow is formed in the downstream duct side wall 48D. The discharge port 52 may be formed at a position adjacent to the duct rear wall 46. The discharge port 52 is connected to the suction fan 36, and the air flow from the developer discharging duct 34 passes through the discharge port 52 and is directed toward the suction fan 36. The discharge port 52 may be formed in the upstream duct side wall 48U.

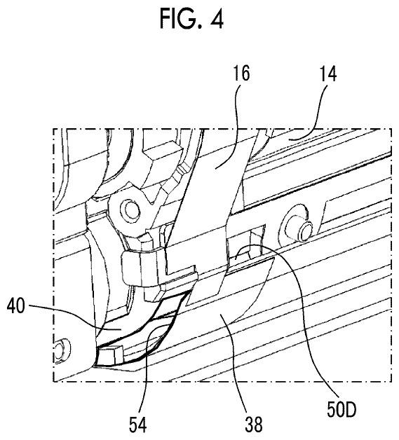

In a case where a sucked developer is deposited in the developer discharging duct 34, an air flow is weak around the deposited developer, and the developer is further deposited. The developer is likely to be deposited in a region where the speed of the air flow is slow, for example, in the vicinity of the duct side wall. In the developer discharging duct 34 of the exemplary embodiment, a side intake port 54 is formed in the downstream duct side wall 48D. FIG. 4 shows an example of the side intake port 54. FIG. 4 is an enlarged view of a portion indicated by an arrow Y in FIG. 1. Air that does not contain a developer, that is, clear air is introduced into the developer discharging duct 34 from a side portion of the developer supply device 13 through the side intake port 54. The deposition of the developer is suppressed by an air flow introduced from the side intake port 54. The side intake port 54 may be formed in the upstream duct side wall 48U or may be formed in both of the two duct side walls 48. In addition, the discharge port 52 and the side intake port 54 may be formed in the same duct side wall 48.

In the process of being conveyed from the collected developer transport passage 22 to the intermediate developer transport passage 24, some of a developer is wound up and floats. For this reason, the end portion of the collected developer transport passage 22 on the downstream side in the transport direction has more floating developers than the upstream side has. The amount of the developer sucked from the suction port 50 is larger at the downstream suction port 50D than at the upstream suction port 50U due to a difference in the amount of the floating developer described above. For this reason, the developer has a large amount of deposition in the vicinity of the downstream duct side wall 48D. As the side intake port 54 is provided in the downstream duct side wall 48D, an air flow is generated in a region where the amount of the developer deposited is large, and the deposition of the developer is suppressed.

A partition wall 56 extending from the downstream duct side wall 48D toward the upstream duct side wall 48U is provided in the developer discharging duct 34. The partition wall 56 extends from between the discharge port 52 and the side intake port 54, and a tip of thereof does not reach the upstream duct side wall 48U. The partition wall 56 may extend such that an edge of the tip thereof exceeds the downstream suction port 50D.

Since the partition wall 56 is provided, an air flow introduced from the side intake port 54 first flows toward the upstream side in the collected developer transport direction. In a case where the air flow reaches the edge of the tip of the partition wall 56, the air flow changes a direction thereof, flows toward the downstream side in the collected developer transport direction (F), and reaches the discharge port 52. A flow passage that first directs the air flow sucked from the side intake port 54 toward the upstream side in the collected developer transport direction (F) and then induces the air flow toward the downstream side is defined as the partition wall 56 in the developer discharging duct. A resistance that the air flow from the side intake port 54 toward the discharge port 52 has received from the flow passage by the partition wall 56 is high compared to a case where there is no partition wall 56. Accordingly, a difference in the resistance that an air flow sucked from the upstream suction port 50U has received from the flow passage is small. In addition, a reduction in the amount of sucked air from the upstream suction port 50U caused by the provision of the side intake port 54 is suppressed.

In a case where the partition wall 56 extends such that the edge of the tip thereof exceeds the downstream suction port 50D, an air flow sucked from the downstream suction port 50D temporarily flows toward the upstream side in the collected developer transport direction (F) due to the partition wall 56 and then changes the direction at the tip of the partition wall 56 to flow to the downstream side toward the discharge port 52. The flow passage that first directs the air flow sucked from the downstream suction port 50D toward the upstream side in the collected developer transport direction (F) and then induces the air flow toward the downstream side is defined as the partition wall 56 in the developer discharging duct. Since the partition wall 56 is provided, a path of the air flow sucked from the downstream suction port 50D is lengthened. In addition, a difference between a resistance received by the air flow and a resistance received by an air flow sucked from the upstream suction port 50U is small, and an imbalance between amounts of air sucked from the two suction ports 50U and 50D is small.

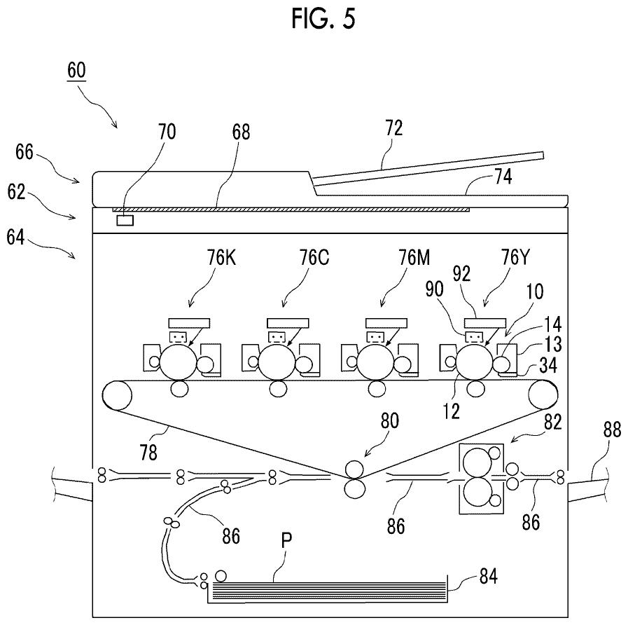

FIG. 5 is a view showing a schematic configuration of an image forming apparatus 60 including the developing device 10 described above. The image forming apparatus 60 includes an image reading unit 62, an image forming portion 64, and a document transport unit 66. The image reading unit 62 is a means for optically reading an image of a document. The document is placed on a platen glass 68, and the image on the document is optically read by an image reading element 70 configured by a CCD or the like. The image of the entire document is read by moving the image reading element 70 along the platen glass 68. In addition, the document may be transported by the document transport unit 66, and the image on the document may be read by the image reading element 70 in the transport process. The document is transported one by one from a document feeding tray 72 of the document transport unit 66 to a document discharge tray 74 and is read in the process. In this case, the image of the entire document is read while the image reading element 70 is stationary.

The image forming portion 64 forms an image on paper P based on image information read by the image reading unit 62 or image information sent from an external device such as a personal computer. The image forming portion 64 is an electrophotographic device that forms a color image on the paper P using four color developers. The image forming portion 64 includes image forming units 76Y, 76M, 76C, and 76K that form developer images of respective colors of yellow (Y), magenta (M), cyan (C), and black (K). The image forming units 76Y, 76M, 76C, and 76K are the same except for the colors for the formation and will be described as the image forming unit 76 with Y, M, C, and K omitted in a case where distinguishing between the colors is not particularly necessary. The image forming portion 64 includes an intermediate transfer belt 78 on which a developer image formed by the image forming unit 76 of each color is transferred, a transfer unit 80 that transfers the developer image on the intermediate transfer belt 78 onto the paper P, and a fixing unit 82 that fixes the transferred developer image onto the paper P. The image forming portion 64 further includes a paper container 84 that accommodates the paper P and a paper transport device 86 that transports the paper P one by one from the paper container 84 to pass through the transfer unit 80 and the fixing unit 82 sequentially.

A developer image of each color formed by the image forming unit 76 is transferred and superimposed onto the intermediate transfer belt 78. The developer image of the intermediate transfer belt 78 is sent to the transfer unit 80 as the intermediate transfer belt 78 is circulated, and is transferred to the paper P transported by the paper transport device 86. The paper P is further transported to the fixing unit 82 by the paper transport device 86 and is heated and pressurized here to fix the developer image to the paper P. The paper P on which the image is formed is sent onto a discharge tray 88 by the paper transport device 86.

As typically shown in a yellow image forming unit 76Y, the developing device 10 is included in the image forming unit 76. The image forming unit 76 includes a charger 90 that charges the surface of the image holding body 12 and an exposure device 92 that emits light such as laser light to the image holding body 12 to form an electrostatic latent image thereon. The exposure device 92 controls the emitted light based on image information acquired from the image reading unit 62 or the external device to form an electrostatic latent image. As described above, a developer is supplied from the development roll 14 onto the image holding body 12 on which the electrostatic latent image is formed, and a latent image is developed.

The developer supply device 13 has the developer discharging duct 34 for discharging a floating developer from the nip and a peripheral region thereof. By discharging the floating developer, scattering of the developer to the image forming apparatus 60, particularly to the inside of the image forming portion 64 is suppressed. Accordingly, contamination of the intermediate transfer belt 78 and the paper transport device 86 is suppressed. As described above, the developing device 10 of the present exemplary embodiment is configured such that blockage of the developer discharging duct 34 is suppressed, and thus, an opportunity of stopping the image forming apparatus 60 caused by the blockage is reduced.

The image forming apparatus 60 includes the four image forming units 76 corresponding to the four color developers. The number of image forming units corresponds to the number of color developers. In a case where there is one color developer, the number of image forming units is one. In the image forming apparatus 60, a developer image formed by the image forming unit 76 is indirectly transferred to the paper P via the intermediate transfer belt 78. Instead thereof, the image forming unit may be configured to directly transfer the developer image to the paper.

### Supplementary Notes

1

A developing device comprising:
a development roll that rotates while holding a developer;
an image holding body that is disposed to face the development roll and that rotates; and
a developer discharging duct through which the developer is sucked from an image holding body side and the developer is discharged to another place,
wherein the developer discharging duct includes
   a duct front wall that is disposed on the image holding body side and that has suction ports for sucking the developer, which are formed in end portions of the duct front wall on both sides in an intersection direction intersecting a rotation movement direction of the development roll,
   a duct rear wall that is positioned on a side opposite to the image holding body with respect to the duct front wall, and
   two duct side walls that are positioned at the end portions on both sides in the intersection direction,
a discharge port for discharging the developer is formed in one duct side wall of the two duct side walls, at a position adjacent to the duct rear wall, and
a side intake port for sucking air is formed in one duct side wall of the two duct side walls.
   2

The developing device according to (((1))),
wherein the discharge port and the side intake port are formed in a downstream duct side wall positioned on a downstream side in a transport direction of a collected developer transport passage through which the developer remaining without being developed to the image holding body is collected from the development roll and is sent along the intersection direction, of the two duct side walls.
   3

The developing device according to (((2))),
wherein the developer discharging duct has a partition wall that extends from a position between the discharge port and the side intake port toward a duct side wall on a side opposite to the downstream duct side wall and that does not reach the duct side wall on the opposite side.
   4

The developing device according to (((3))),
wherein an edge of a tip of the partition wall is positioned on an upstream side in the transport direction of the collected developer transport passage with respect to a downstream suction port that is the suction port positioned on a downstream duct side wall side in the intersection direction.
   5

The developing device according to (((2))),
wherein an air induction path in which air sucked from the side intake port is induced to be directed to an upstream side in the transport direction of the collected developer transport passage temporarily and then is induced to be directed to the discharge port is provided in the developer discharging duct.
   6

The developing device according to (((5))),
wherein in the air induction path, air sucked from a downstream suction port that is the suction port positioned on a downstream duct side wall side is induced to be directed to the upstream side in the transport direction of the collected developer transport passage temporarily and then is induced to be directed to the discharge port.
   7

An image forming apparatus comprising:
the developing device according to any one of (((1))) to (((6)));
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a development roll that rotates while holding a developer;
an image holding body that is disposed to face the development roll and that rotates; and
a developer discharging duct through which the developer is sucked from an image holding body side and the developer is discharged to another place,
wherein the developer discharging duct includes
a duct front wall that is disposed on the image holding body side and that has suction ports for sucking the developer, which are formed in end portions of the duct front wall on both sides in an intersection direction intersecting a rotation movement direction of the development roll,
a duct rear wall that is positioned on a side opposite to the image holding body with respect to the duct front wall, and
two duct side walls that are positioned at the end portions on both sides in the intersection direction,
a discharge port for discharging the developer is formed in one duct side wall of the two duct side walls, at a position adjacent to the duct rear wall, and
a side intake port for sucking air is formed in one duct side wall of the two duct side walls.

2. The developing device according to claim 1,
wherein the discharge port and the side intake port are formed in a downstream duct side wall positioned on a downstream side in a transport direction of a collected developer transport passage through which the developer remaining without being developed to the image holding body is collected from the development roll and is sent along the intersection direction, of the two duct side walls.

3. The developing device according to claim 2,
wherein the developer discharging duct has a partition wall that extends from a position between the discharge port and the side intake port toward a duct side wall on a side opposite to the downstream duct side wall and that does not reach the duct side wall on the opposite side.

4. The developing device according to claim 3,
wherein an edge of a tip of the partition wall is positioned on an upstream side in the transport direction of the collected developer transport passage with respect to a downstream suction port that is the suction port positioned on a downstream duct side wall side in the intersection direction.

5. The developing device according to claim 2,
wherein an air induction path in which air sucked from the side intake port is induced to be directed to an upstream side in the transport direction of the collected developer transport passage temporarily and then is induced to be directed to the discharge port is provided in the developer discharging duct.

6. The developing device according to claim 5,
wherein in the air induction path, air sucked from a downstream suction port that is the suction port positioned on a downstream duct side wall side is induced to be directed to the upstream side in the transport direction of the collected developer transport passage temporarily and then is induced to be directed to the discharge port.

7. An image forming apparatus comprising:
the developing device according to claim 1;
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.

8. An image forming apparatus comprising:
the developing device according to claim 2;
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.

9. An image forming apparatus comprising:
the developing device according to claim 3;
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.

10. An image forming apparatus comprising:
the developing device according to claim 4;
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.

11. An image forming apparatus comprising:
the developing device according to claim 5;
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.

12. An image forming apparatus comprising:
the developing device according to claim 6;
a charger that charges a surface of the image holding body;
an exposure device that exposes the charged image holding body with light to form an electrostatic latent image on the image holding body;
a transfer unit that directly or indirectly transfers a developer image, which is formed by developing the electrostatic latent image with a developer supplied from the development roll, from the development roll to paper;
a fixing unit that fixes the developer image transferred on the paper to the paper; and
a transport device that transports the paper to pass through the transfer unit and the fixing unit.
